(19) United States
(12) Patent Application Publication
(10) Pub. No.: US 2008/0081160 A1
(43) Pub. Date: Apr. 3, 2008

(54) Ink Receptive Coatings For Woven and Nonwoven Substrates

(75) Inventors: Gary A. Anderle, North Olmsted, OH (US); Jack C. Scott JR., Lake Wylie, SC (US); Timothy E. Felmet, Rock Hill, SC (US)

Correspondence Address: LEGAL DEPARTMENT;LUBRIZOL ADVANCED MATERIALS, INC, 9911 BRECKSVILLE ROAD, CLEVELAND, OH, 44141-3247, US

(73) Assignee: LUBRIZOL ADVANCED MATERIALS, INC., Cleveland, OH (US)

(21) Appl. No.: 11/863,339

(22) Filed: Sep. 28, 2007

Related U.S. Application Data
(60) Provisional application No. 60/827,346, filed on Sep. 28, 2006.

(51) Int. Cl. B41M 5/00; C08G 73/00; C08J 3/05

(52) U.S. Cl. 428/195.1; 524/612; 528/422

(57) ABSTRACT

A print receptive polyurethane coating is described. It is derived from a non-ionically stabilized polyurethane dispersion and an ink receptive particulate. Coatings and films for textiles and other articles and applications using such polyurethanes have been described.

### CROSS REFERENCE

This application claims priority from U.S. Provisional Application Ser. No. 60/827,346 filed on Sep. 28, 2006.

### FIELD OF THE INVENTION

This invention relates to nonionically stabilized polyurethane compositions and their use as coatings with good printability, e.g., an ink receptive layer in a nonwoven or woven composite. In one embodiment, the polyurethanes used as the binders are characterized as polyurethanes having high moisture vapor transmission rates (MVTR). Such polyurethanes comprise (a) poly(alkylene oxide) (optionally as side-chain units) in an amount comprising about 12 wt. % to about 80 wt. % of the polyurethane, wherein (i) alkylene oxide groups in said poly(alkylene oxide) units have from 2 to 4 carbon atoms.

### BACKGROUND OF THE INVENTION

U.S. Pat. No. 5,700,867 relates to an aqueous polyurethane dispersion having an ionic functional group, polyoxyethylene units and hydrazine groups and used as a composition for ink, coating or adhesive. The polyoxyethylene units can be in the main chain, at the end of the main chain or in side chains of the aqueous polyurethane. The content of polyoxyethylene units is about 20% by weight or less of the weight of the resin. Desirable properties of the composition include storage stability, water resistance, pigment dispersibility, and adhesion.

U.S. Pat. No. 5,043,381 relates to an aqueous dispersion of nonionic water-dispersible polyurethane having pendant polyoxyethylene chains and one crosslink per 3,000 to 100,000 atomic weight units. U.S. Pat. No. 4,992,507 relates to an aqueous dispersion of a nonionic, water-dispersible polyurethane having pendant polyoxyethylene chains and free acid or free tertiary amino groups. Diols and diisocyanates having pendant polyoxyethylene chains are mentioned generally in both of the latter two patents, such as those in U.S. Pat. Nos. 3,905,929 and 3,920,598, respectively. The dispersions are useful as coating compositions.

U.S. Pat. No. 4,983,662 relates to an aqueous selfcrosslinkable coating composition comprising an aqueous dispersion of at least one polyurethane and having hydrazine (or hydrazone) functional groups and carbonyl functional groups disposed therein to provide a selfcrosslinkable reaction, in which the polyurethane polymer takes part, via azomethine formation during and/or after film formation.

U.S. Pat. No. 4,190,566 relates to non-ionic, water-dispersible polyurethanes having a substantially linear molecular structure and lateral polyalkylene oxide chains having about 3 to 30% by weight of lateral polyalkylene oxide polyether chains. The chains consist of about 40-95% ethylene oxide units and 5-60% certain other alkylene oxide units selected from the group consisting of propylene oxide, butylene oxide and styrene oxide. Coatings are among the many uses listed.

U.S. Pat. No. 4,092,286 relates to water-dispersible polyurethane elastomers having a substantially linear molecular structure, characterized by (a) lateral polyalkylene oxide units of from about 0.5 to 10% by weight, based on the polyurethane as a whole and (b) a content of ═N⁺═, —COO⁻ or —SO₃⁻ groups of from about 0.1 to 15 milliequivalents per 100 g. Coatings are among the many uses listed.

A waterborne polyurethane dispersion is desired that can be used to produce films, coatings and other compositions having improved printability in applications such as water-borne and solvent borne laser jet printing compared to printable coatings of the prior art.

### SUMMARY OF THE INVENTION

A composition for creating an ink receptive coating, the coating, and an article made from printing on the ink receptive coating, optionally including a woven or non-woven substrate, is described. Particular nonionically stabilized polyurethane dispersions are the starting material for the ink receptive coating. The combination of nonionic colloidal stabilization with wide formulation options in making the polyurethane results in an ink receptive coating with optimizable wetting (contact angle of the ink) and resistance for a variety of environmental factors like rain, UV exposure, heat, etc. To enhance final color and line definition a variety of inorganic salts, e.g., alum, and anionic or cationic polymer flocculants can be included in the ink receptive coating.

Printable coatings and articles (on woven, non-woven, and/or films) having coatings made using such dispersions of polymers and ink receptive particulate have customizable receptivity to be used with a wider variety of ink systems, woven and non-woven substrates, and various environmental resistance after printing.

### DETAILED DESCRIPTION OF THE INVENTION

The present invention relates to dispersions of polyurethanes and coatings therefrom for woven and non-woven substrates that are receptive to dyes and pigments in ink.

There is currently a lot of interest in coatings that are ink receptive. Some disclosures use water or solvent insoluble polymers to promote resistance to the water and solvents in inks. Some disclosures use water or solvent soluble binders in the coating that are very receptive/interactive to inks containing water or solvent. Other disclosures use appropriate ionic species; e.g., as additives, part of a polymer, as surface modifiers on particulate, etc.; that destabilize dispersions of pigments or bind the dyes by ionic interactions in the coating. Other disclosures speak to optimizing contact angles when the ink first contacts the ink receptive coatings. Sometimes it is desirable if the contact angle is low, such that the coating is receptive to the ink so the ink spreads on the coating or is taken into the coating. In other applications where the ink is desired to be only on the surface, very accurately applied to small areas, or in the first few nanometers of the coating surface; it is desirable if the contact angle is high and the ink stays exactly where applied and only there. All of the applications benefit when the coating is robust enough to withstand environmental factors that it will be exposed to such as UV radiation, flexing, water or solvent printing solutions, rain, snow, oils from skin contact, staining, etc.

It is generally not economically viable to develop separate robust coatings with different water permeability and contact angles for every different type of possible ink printing operation to a surface, e.g., such as solvent borne ink jet, water borne ink jet, graveure, stencil, flexographic, lithographic, etc. It would be much more desirable to have a compatible blend of a relatively hydrophobic polymer and a relatively hydrophilic polymer that could be blended in different ratios to obtain a desired contact angle for wetting with the preferred ink and a desired permeability to the carrier in the ink. It would also be desirable if the coating was applied as a water-based coating. It would be desirable that the stabilization mechanism for the polymer in a water-based coating be non-ionic or contain a substantial portion of nonionic stabilizer so that cationic or anionic additives which are added to de-stabilize pigment dispersions or ionically bind to dyes can be added to the coating without destabilizing the polyurethane dispersion.

Such compatible blends of a relatively hydrophobic and relatively hydrophilic polymer already exist for another application. Nonionically stabilized dispersions of polyurethanes with substantial amounts of poly(alkylene oxide) are described in patents on nonionically stabilize polyurethane dispersions. U.S. Pat. No. 6,897,281 describes a subset of those polymers where the poly(alkylene oxide) is in lateral side chains. Some of those embodiments of U.S. Pat. No. 6,897,281 are commercially available for coating woven and nonwoven fabrics. Lubrizol Advanced Materials, Inc., in Cleveland, Ohio sells some of these products under the Permax™ brand name. The Permax™ products are marketed as polyurethanes with high moisture vapor transmission for coating fabrics to impart water repellency but while water repellant retaining good transmission rates for water vapors. The coated fabric is good for water repellant outerwear, sports clothing, hazardous materials protective wear and some other coated fabric applications where water repellency is desired such as awnings and tents.

U.S. Pat. No. 6,897,218 also describes blending the nonionically stabilized polyurethanes or the polyurethanes before dispersion with other polymer to create various polymer blends, which are also useful in this application. The prior patent describes a list of additives that can be added to the polyurethane or its dispersion such as pigments, various environmental stabilizers and protectorants, crosslinkers, flame retardants etc. to make a more desirable coating. All of the earlier disclosure of U.S. Pat. No. 6,897,281 is incorporated by reference for its teachings on possible variations as applied to the current topic of ink receptive coatings. Alternatively, if less water interaction is desired from the coating, polyurethane dispersions such as taught in U.S. Pat. No. 4,190,566, hereby incorporated by reference, may be used.

The ink receptive coating of this disclosure can be used with a variety of substrates to make a printable/printed article. Substrates include wovens and non-woven fabrics, and a subgroup thereof referred to as paper and cardboard. The ink receptive coating may also be applied to polymeric films that do not have fibrous reinforcement, e.g., plasticized poly(vinyl chloride), polyethylene films, polypropylene films, etc. The ink receptive coating may be only a fraction of a millimeter thick up to a fairly thick coating. The ink receptive coating can be pigmented or clear. It can be any color, although light colors (white, beige, etc.) are generally desirable for enhanced contrast with ink printing. The final article can include a variety of intermediate layers as long as the ink receptive layer is available to accept the ink. While a waterborne polyurethane dispersion is a preferred way of generating the ink receptive coating, similar compositions are available as bulk polymers that can be formed into films by extrusion/calendaring, etc.

Generally, polyurethanes have excellent durability, scratch resistance, resistance to cracking during flexing, etc., as compared to other large volume polymers. Technology is available to stabilize them against UV damage (especially if aliphatic isocyanates are used), ozone, solvents, etc. Nonionically stabilized polyurethane dispersions are very stable against coagulation by additives due to the nonionic stabilization mechanism.

An optional additive that is unique to ink receptive coatings and not used as often in high moisture vapor transmission coatings is an additive to stabilize or bind the pigment or dye of the ink near its initial contact point. This additive may be a cationic species if the pigment is anionically stabilized against coagulation or if the dye contains anionic groups. Cationic groups, molecules, particulate, or polymers with cationic groups for use in ink receptive coatings are well known in the patent literature for ink receptive coatings. Since the nonionically stabilized polyurethane will not be colloidally destabilized by cationic species, almost any cationic species can be added to the polyurethane dispersion and used in the ink receptive coating. Similarly, an anionic groups, molecules, particulate, or polymers with anionic groups can be used with the polyurethane dispersion and in the ink receptive coating to help destabilize pigment or bind to dyes that use cationic dispersants or that contains cationic groups. Anionic groups, molecules, particulate, and polymers with anionic groups typically have little effect on colloidal stability of nonionically stabilized polyurethane dispersions. The poly(alkylene oxide), some of the other moderate to high molecular weight polyester polyols and related polyols impart some compatibility for anionic groups and/or cationic groups in the polyurethane coating.

In one embodiment, the polyurethane of the polyurethane dispersion is present in the coating in amounts of at least 10 wt. %, more desirably at least 20 wt. % and preferably at least 30 wt. % of the total coating weight. As nonionic stabilization is an desired feature in one embodiment desirably at least 5, 10, 12, 15, or 20 wt. % of the polyurethane of the polyurethane dispersion is nonionic stabilizing moieties either as attached poly(alkylene oxide) or poly(alkylene oxide) based surfactant. In one embodiment, at least 3, 5, or 10 wt. % of the polyurethane is a poly(alkylene oxide) based surfactant. As expressed later in the specification, in one embodiment, the poly(alkylene oxide) in side chains is from about 12 to about 80 wt. % of the polyurethane, or about 15 to about 60 wt. % or about 20 to about 50 wt. % of the total polyurethane.

In one embodiment where UV exposure resistance is important, at least 50 wt. % of the residues from di or polyisocyanates used to make the polyurethane are aliphatic rather than aromatic, meaning that primarily aliphatic isocyanates were used. In one embodiment groups, molecules, particles, or polymers with ionic charges such as those with cationic or anionic charges are used to help prevent migration of the pigments or dyes in the inks used to print the ink receptive coating. These ionic groups can come from inorganic salts such as alum, calcium chloride, aluminum chloride and the like. The ionic groups can come from molecules or polymers that have amide, carboxylic acid, carboxylate, amine groups available. The polymers include cationically modified natural gums or starches. The polymers include those from acrylic, acrylamide, and/or epichlorohydrin monomers. These polymers and their manufacture and uses are well known to the art. The ionic species can be present at concentrations of at least 1, 2, 3, 5 or 8 wt. % based on the weight of the dry ink receptive coating. Similar polymers known as rheology modifiers may also be present to aid in the application of the ink receptive coating to a substrate. Rheology modifiers may be present at concentrations from above 0.1 part by weight and above based on 100 parts of polyurethane. Often less than 1 part of rheology modifier is necessary.

Other polymers may be blended with the polyurethane before or after the polyurethane is dispersed in an aqueous phase. These polymers include one or more acrylate polymers or copolymers, vinyl acetate polymers or copolymers, or and/or vinyl chloride polymer or copolymer. These may be present from about 10 parts by weight to about 400 parts by weight per every 100 parts by weight of polyurethane. Various fillers may be added to add opacity, volume, change ink interaction, etc. These include talc, calcium carbonate, TiO₂, and precipitated silica. These are typically present above 10 parts by weight per 100 parts by weight of the polyurethane.

The ink receptive coating is particularly desirable where multicolor images or photographs are to be printed on the coating. Thus, in one embodiment, it is desirable that at least three different pigments and/or dyes be present in the printed image. As ink receptive coatings would be desirable on a variety of banners, signage, and related advertising and promotional activity, it is desirable that the coating and substrate be printable on ink jet printers of the water-borne ink and solvent borne ink types. This facilitates low volume production and/or higher volume production. The ink receptive coating may also be applied to a substrate post printing to change a banner, advertisement, promotional sign, etc. In those cases, the ink receptive coating can be applied to an existing substrate with conventional technology such as melt bonding, pressure sensitive adhesive, (water, solvent, or radiation) activated adhesive, etc.

A method to prepare the ink receptive polyurethane comprises:

(A) reacting to form an isocyanate-terminated prepolymer (1) at least one polyisocyanate having an average of about two or more isocyanate groups; (2) at least one active hydrogen-containing compound comprising (a) poly(alkylene oxide) side-chain units in an amount comprising about 12 wt. % to about 80 wt. % of said polyurethane, wherein (i) alkylene oxide groups in said poly(alkylene oxide) side-chain units have from 2 to 10 carbon atoms and are unsubstituted, substituted, or both unsubstituted and substituted, (ii) at least about 50 wt. % of said alkylene oxide groups are ethylene oxide, and (iii) in one embodiment said amount of said side-chain units is at least about 30 wt. % of the prepolymer when the molecular weight of said side-chain units is less than about 600 grams/mole, at least about 15 wt. % when the molecular weight of said side-chain units is from about 600 to about 1,000 grams/mole, and at least about 12 wt. % when the molecular weight of said side-chain units is more than about 1,000 grams/mole, and (b) poly(ethylene oxide) main-chain units in an amount comprising less than about 25 wt. % of said polyurethane; (3) preferably at least one other active hydrogen-containing compound not containing poly(alkylene oxide) side-chain units; and (4) optionally at least one compound having at least one crosslinkable functional group, in order to form an isocyanate-terminated prepolymer;

(B) dispersing said prepolymer in water, and chain extending said prepolymer by reaction with at least one of water, inorganic or organic polyamine having an average of about 2 or more primary and/or secondary amine groups, polyalcohols, ureas, or combinations thereof; and

(C) thereafter, further processing the chain-extended dispersion of step (B) in order to form a composition or article desirably having an upright moisture vapor transmission rate (MVTR) of more than about 500 gms/m²/24 hr.

Optionally, at least one plasticizer is introduced into the reaction mixture at any time during prepolymer formation, before the prepolymer is dispersed in water. It can also be added to a finished dispersion. The process typically is conducted in the substantial absence and preferably in the complete absence of an organic solvent or a diluent other than the plasticizer.

Before continuing with discussion of the preferred process, it is noted that other processes can also be used to manufacture the polyurethanes of the present invention, including but not limited to the following:
1. Dispersing prepolymer by shear forces with emulsifiers (external emulsifiers, such as surfactants, or internal emulsifiers having anionic and/or cationic groups as part of or pendant to the polyurethane backbone, and/or as end groups on the polyurethane backbone).
2. Acetone process. A prepolymer is formed with or without the presence of acetone, MEK, and/or other polar solvents that are non-reactive and easily distilled. The prepolymer is further diluted in said solvents as necessary, and chain extended with an active hydrogen-containing compound. Water is added to the chain-extended polyurethane, and the solvents are distilled off. A variation on this process would be to chain extend the prepolymer after its dispersion into water.
3. Melt dispersion process. An isocyanate-terminated prepolymer is formed, and then reacted with an excess of ammonia or urea to form a low molecular weight oligomer having terminal urea or biuret groups. This oligomer is dispersed in water and chain extended by methylolation of the biuret groups with formaldehyde.
4. Ketazine and ketimine processes. Hydrazines or diamines are reacted with ketones to form ketazines or ketimines. These are added to a prepolymer, and remain inert to the isocyanate. As the prepolymer is dispersed in water, the hydrazine or diamine is liberated, and chain extension takes place as the dispersion is taking place.
5. Continuous process polymerization. An isocyanate-terminated prepolymer is formed. This prepolymer is pumped through high shear mixing head(s) and dispersed into water and then chain extended at said mixing head(s), or dispersed and chain extended simultaneously at said mixing head(s). This is accomplished by multiple streams consisting of prepolymer (or neutralized prepolymer), optional neutralizing agent, water, and optional chain extender and/or surfactant.
6. Reverse feed process. Water and optional neutralizing agent(s) and/or extender amine(s) are charged to the prepolymer under agitation. The prepolymer can be neutralized before water and/or diamine chain extender is added.
7. Solution polymerization.
8. Bulk polymerization, including but not limited to extrusion processes.

The compositions of the present invention are conveniently referred to as polyurethanes because they contain urethane groups. They can be more accurately described as poly(urethane/urea)s if the active hydrogen-containing compounds are polyols and polyamines. It is well understood by those skilled in the art that “polyurethanes” is a generic term used to describe polymers obtained by reacting isocyanates with at least one hydroxyl-containing compound, amine-containing compound, or mixture thereof. It also is well understood by those skilled in the art that polyurethanes also include allophanate, biuret, carbodiimide, oxazolidinyl, isocyanurate, uretdione, and other linkages in addition to urethane and urea linkages.

As used herein, the term “wt. %” means the number of parts by weight of monomer per 100 parts by weight of polymer on a dry weight basis, or the number of parts by weight of ingredient per 100 parts by weight of specified composition. As used herein, the term “molecular weight” means number average molecular weight.

Polyisocyanates

Suitable polyisocyanates have an average of about two or more isocyanate groups, preferably an average of about two to about four isocyanate groups and include aliphatic, cycloaliphatic, araliphatic, and aromatic polyisocyanates, used alone or in mixtures of two or more. Diisocyanates are more preferred.

Specific examples of suitable aliphatic polyisocyanates include alpha, omega-alkylene diisocyanates having from 5 to 20 carbon atoms, such as hexamethylene-1,6-diisocyanate, 1,12-dodecane diisocyanate, 2,2,4-trimethyl-hexamethylene diisocyanate, 2,4,4-trimethyl-hexamethylene diisocyanate, 2-methyl-1,5-pentamethylene diisocyanate, and the like. Polyisocyanates having fewer than 5 carbon atoms can be used but are less preferred because of their high volatility and toxicity. Preferred aliphatic polyisocyanates include hexamethylene-1,6-diisocyanate, 2,2,4-trimethylhexamethylene-diisocyanate, and 2,4,4-trimethyl-hexamethylene diisocyanate.

Specific examples of suitable cycloaliphatic polyisocyanates include dicyclohexylmethane diisocyanate, (commercially available as Desmodur™ W from Bayer Corporation), isophorone diisocyanate, 1,4-cyclohexane diisocyanate, 1,3-bis(isocyanatomethyl)cyclohexane, and the like. Preferred cycloaliphatic polyisocyanates include dicyclohexylmethane diisocyanate and isophorone diisocyanate.

Specific examples of suitable araliphatic polyisocyanates include m-tetramethyl xylylene diisocyanate, p-tetramethyl xylylene diisocyanate, 1,4-xylylene diisocyanate, 1,3-xylylene diisocyanate, and the like. A preferred araliphatic polyisocyanate is tetramethyl xylylene diisocyanate.

Examples of suitable aromatic polyisocyanates include 4,4′-diphenylmethylene diisocyanate), toluene diisocyanate, their isomers, naphthalene diisocyanate, and the like. A preferred aromatic polyisocyanate is toluene diisocyanate.

Active Hydrogen-Containing Compounds

The term “active hydrogen-containing” refers to compounds that are a source of active hydrogen and that can react with isocyanate groups via the following reaction: —NCO+H—X→—NH—C(═O)—X. Examples of suitable active hydrogen-containing compounds include but are not limited to polyols, polythiols and polyamines.

As used herein, the term “alkylene oxide” includes both alkylene oxides and substituted alkylene oxides having 2 to 10 carbon atoms. In a preferred embodiment, the active hydrogen-containing compounds used in this invention have poly(alkylene oxide) side chains sufficient in amount to comprise about 12 wt. % to about 80 wt. %, preferably about 15 wt. % to about 60 wt. %, and more preferably about 20 wt. % to about 50 wt. %, of poly(alkylene oxide) units in the final polyurethane on a dry weight basis. In that embodiment, at least about 50 wt. %, preferably at least about 70 wt. %, and more preferably at least about 90 wt. % of the poly(alkylene oxide) side-chain units comprise poly(ethylene oxide), and the remainder of the side-chain poly(alkylene oxide) units can comprise alkylene oxide and substituted alkylene oxide units having from 3 to about 10 carbon atoms, such as propylene oxide, tetramethylene oxide, butylene oxides, epichlorohydrin, epibromohydrin, allyl glycidyl ether, styrene oxide, and the like, and mixtures thereof. The term “final polyurethane” means the polyurethane produced after formation of the prepolymer followed by the chain extension step as described more fully hereafter.

In a preferred embodiment, such active hydrogen-containing compounds provide less than about 25 wt. %, more preferably less than about 15 wt. % and most preferably less than about 5 wt. % poly(ethylene oxide) units in the backbone (main chain) based upon the dry weight of final polyurethane, since such main-chain poly(ethylene oxide) units tend to cause swelling of polyurethane particles in the waterborne polyurethane dispersion and also contribute to lower in-use tensile strength of articles made from the polyurethane dispersion. In a preferred embodiment, the amount of the side-chain units is (i) at least about 30 wt. % when the molecular weight of the side-chain units is less than about 600 grams/mole, (ii) at least about 15 wt. % when the molecular weight of the side-chain units is from about 600 to about 1,000 grams/mole, and (iii) at least about 12 wt. % when the molecular weight of said side-chain units is more than about 1,000 grams/mole. Mixtures of active hydrogen-containing compounds having such poly(alkylene oxide) side chains can be used with active hydrogen-containing compounds not having such side chains.

Preferably, the polyurethanes of the present invention also have reacted therein at least one active hydrogen-containing compound not having said side chains and typically ranging widely in molecular weight from about 50 to about 10,000 grams/mole, preferably about 200 to about 6,000 grams/mole, and more preferably about 300 to about 3,000 grams/mole. Suitable active-hydrogen containing compounds not having said side chains include any of the amines and polyols described hereafter.

The term “polyol” denotes any molecular weight product having an average of about two or more hydroxyl groups per molecule. Examples of such polyols that can be used in the present invention include higher polymeric polyols such as polyester polyols and polyether polyols, as well as polyhydroxy polyester amides, hydroxyl-containing polycaprolactones, hydroxyl-containing acrylic interpolymers, hydroxyl-containing epoxides, polyhydroxy polycarbonates, polyhydroxy polyacetals, polyhydroxy polythioethers, polysiloxane polyols, ethoxylated polysiloxane polyols, polybutadiene polyols and hydrogenated polybutadiene polyols, polyacrylate polyols, halogenated polyesters and polyethers, and the like, and mixtures thereof. The polyester polyols, polyether polyols, polycarbonate polyols, polysiloxane polyols, and ethoxylated polysiloxane polyols are preferred.

Poly(alkylene oxide) side chains can be incorporated into such polyols by methods well known to those skilled in the art. For example, active hydrogen-containing compounds having poly(alkylene oxide) side chains include diols having poly(ethylene oxide) side chains such as those described in U.S. Pat. No. 3,905,929 (incorporated herein by reference in its entirety). Further, U.S. Pat. No. 5,700,867 (incorporated herein by reference in its entirety) teaches methods for incorporation of poly(ethylene oxide) side chains at col. 4, line 35 to col. 5, line 45. A preferred active hydrogen-containing compound having poly(ethylene oxide) side chains is trimethylol propane monoethoxylate mether ether, available as Tegomer D-3403 from Degussa-Goldschmidt. U.S. Pat. No. 6,576,702 discloses plasticized waterborne polyurethanes and manufacturing processes therefore. It is incorporated by reference for its teachings on polyurethanes that have poly(alkylene oxide) chains but not necessary lateral side chains and not necessarily high moisture vapor transmission.

The polyester polyols typically are esterification products prepared by the reaction of organic polycarboxylic acids or their anhydrides with a stoichiometric excess of a diol. Examples of suitable polyols for use in the reaction include poly(glycol adipate)s, poly(ethylene terephthalate) polyols, polycaprolactone polyols, orthophthalic polyols, sulfonated and phosphonated polyols, and the like, and mixtures thereof.

The diols used in making the polyester polyols include alkylene glycols, e.g., ethylene glycol; 1,2- and 1,3-propylene glycols; 1,2-, 1,3-, 1,4-, and 2,3-butylene glycols; hexane diols; neopentyl glycol; 1,6-hexanediol; 1,8-octanediol; and other glycols such as bisphenol-A; cyclohexane diol; cyclohexane dimethanol (1,4-bis-hydroxymethylcycohexane); 2-methyl-1,3-propanediol; 2,2,4-trimethyl-1,3-pentanediol; diethylene glycol; triethylene glycol; tetraethylene glycol; polyethylene glycol; dipropylene glycol; polypropylene glycol; dibutylene glycol; polybutylene glycol; dimerate diol; hydroxylated bisphenols; polyether glycols; halogenated diols; and the like; and mixtures thereof. Preferred diols include ethylene glycol, diethylene glycol, butylene glycol, hexane diol, and neopentyl glycol.

Suitable carboxylic acids used in making the polyester polyols include dicarboxylic acids and tricarboxylic acids and anhydrides, e.g., maleic acid, maleic anhydride, succinic acid, glutaric acid, glutaric anhydride, adipic acid, suberic acid, pimelic acid, azelaic acid, sebacic acid, chlorendic acid, 1,2,4-butane-tricarboxylic acid, phthalic acid, the isomers of phthalic acid, phthalic anhydride, fumaric acid, dimeric fatty acids such as oleic acid, and the like, and mixtures thereof. Preferred polycarboxylic acids used in making the polyester polyols include aliphatic or aromatic dibasic acids.

The preferred polyester polyol is a diol. Preferred polyester diols include poly(butanediol adipate); hexane diol adipic acid and isophthalic acid polyesters such as hexane adipate isophthalate polyester; hexane diol neopentyl glycol adipic acid polyester diols, e.g., Piothane 67-3000 HNA (Panolam Industries) and Piothane 67-1000 HNA; as well as propylene glycol maleic anhydride adipic acid polyester diols, e.g., Piothane 50-1000 PMA; and hexane diol neopentyl glycol fumaric acid polyester diols, e.g., Piothane 67-500 HNF. Other preferred polyester diols include Rucoflex® S1015-35, S1040-35, and S-1040-110 (Bayer Corporation).

Polyether diols may be substituted in whole or in part for the polyester diols. Polyether polyols are obtained in known manner by the reaction of (A) the starting compounds that contain reactive hydrogen atoms, such as water or the diols set forth for preparing the polyester polyols, and (B) alkylene oxides, such as ethylene oxide, propylene oxide, butylene oxide, styrene oxide, tetrahydrofuran, epichlorohydrin, and the like, and mixtures thereof. Preferred polyethers include poly(propylene glycol), polytetrahydrofuran, and copolymers of poly(ethylene glycol) and poly(propylene glycol).

Polycarbonates include those obtained from the reaction of (A) diols such 1,3-propanediol, 1,4-butanediol, 1,6-hexanediol, diethylene glycol, triethylene glycol, tetraethylene glycol, and the like, and mixtures thereof with (B) diarylcarbonates such as diphenylcarbonate or using carbonate forming materials such as phosgene.

Polyacetals include the compounds that can be prepared from the reaction of (A) aldehydes, such as formaldehyde and the like, and (B) glycols such as diethylene glycol, triethylene glycol, ethoxylated 4,4′-dihydroxy-diphenyldimethylmethane, 1,6-hexanediol, and the like. Polyacetals can also be prepared by the polymerization of cyclic acetals.

The aforementioned diols useful in making polyester polyols can also be used as additional reactants to prepare the isocyanate terminated prepolymer.

Instead of a long-chain polyol, a long-chain amine may also be used to prepare the isocyanate-terminated prepolymer. Suitable long-chain amines include polyester amides and polyamides, such as the predominantly linear condensates obtained from reaction of (A) polybasic saturated and unsaturated carboxylic acids or their anhydrides, and (B) polyvalent saturated or unsaturated aminoalcohols, diamines, polyamines, and the like, and mixtures thereof.

Diamines and polyamines are among the preferred compounds useful in preparing the aforesaid polyester amides and polyamides. Suitable diamines and polyamines include 1,2-diaminoethane, 1,6-diaminohexane, 2-methyl-1,5-pentanediamine, 2,2,4-trimethyl-1,6-hexanediamine, 1,12-diaminododecane, 2-aminoethanol, 2-[(2-aminoethyl)amino]-ethanol, piperazine, 2,5-dimethylpiperazine, 1-amino-3-aminomethyl-3,5,5-trimethylcyclohexane (isophorone diamine or IPDA), bis-(4-aminocyclohexyl)-methane, bis-(4-amino-3-methyl-cyclohexyl)-methane, 1,4-diaminocyclohexane, 1,2-propylenediamine, hydrazine, urea, amino acid hydrazides, hydrazides of semicarbazidocarboxylic acids, bis-hydrazides and bis-semicarbazides, diethylene triamine, triethylene tetramine, tetraethylene pentamine, pentaethylene hexamine, N,N,N-tris-(2-aminoethyl)amine, N-(2-piperazinoethyl)-ethylene diamine, N,N′-bis-(2-aminoethyl)-piperazine, N,N,N′-tris-(2-aminoethyl)ethylene diamine, N—[N-(2-aminoethyl)-2-aminoethyl]-N′-(2-aminoethyl)-piperazine, N-(2-aminoethyl)-N′-(2-piperazinoethyl)-ethylene diamine, N,N-bis-(2-aminoethyl)-N-(2-piperazinoethyl)amine, N,N-bis-(2-piperazinoethyl)-amine, polyethylene imines, iminobispropylamine, guanidine, melamine, N-(2-aminoethyl)-1,3-propane diamine, 3,3′-diaminobenzidine, 2,4,6-triaminopyrimidine, polyoxypropylene amines, tetrapropylenepentamine, tripropylenetetramine, N,N-bis-(6-aminohexyl)amine, N,N′-bis-(3-aminopropyl)ethylene diamine, and 2,4-bis-(4′-aminobenzyl)-aniline, and the like, and mixtures thereof. Preferred diamines and polyamines include 1-amino-3-aminomethyl-3,5,5-trimethylcyclohexane (isophorone diamine or IPDA), bis-(4-aminocyclohexyl)-methane, bis-(4-amino-3-methylcyclohexyl)-methane, ethylene diamine, diethylene triamine, triethylene tetramine, tetraethylene pentamine, and pentaethylene hexamine, and the like, and mixtures thereof. Other suitable diamines and polyamines include Jeffamine® D-2000 and D-4000, which are amine-terminated polypropylene glycols, differing only by molecular weight, and which are available from Huntsman Chemical Company.

Prepolymer Ratios of Isocyanate to Active Hydrogen

The ratio of isocyanate to active hydrogen in the prepolymer typically ranges from about 1.3/1 to about 2.5/1, preferably from about 1.5/1 to about 2.1/1, and more preferably from about 1.7/1 to about 2/1.

Compounds Having at Least One Crosslinkable Functional Group

Compounds having at least one crosslinkable functional group include those having carboxylic, carbonyl, amine, hydroxyl, and hydrazide groups, and the like, and mixtures of such groups. The typical amount of such optional compound is up to about 1 milliequivalent, preferably from about 0.05 to about 0.5 milliequivalent, and more preferably from about 0.1 to about 0.3 milliequivalent per gram of final polyurethane on a dry weight basis.

The preferred monomers for incorporation into the isocyanate-terminated prepolymer are hydroxy-carboxylic acids having the general formula (HO)ₓQ(COOH)_{y}, wherein Q is a straight or branched hydrocarbon radical having 1 to 12 carbon atoms, and x and y are 1 to 3. Examples of such hydroxy-carboxylic acids include citric acid, dimetlhylolpropanoic acid (DMPA), dimethylol butanoic acid (DMBA), glycolic acid, lactic acid, malic acid, dihydroxymaleic acid, tartaric acid, hydroxypivalic acid, and the like, and mixtures thereof. Dihydroxy-carboxylic acids are more preferred with dimethylolpropanoic acid (DMPA) being most preferred.

Other suitable compounds providing crosslinkability include thioglycolic acid, 2,6-dihydroxybenzoic acid, and the like, and mixtures thereof.

Catalysts

The formation of the isocyanate-terminated prepolymer may be achieved without the use of a catalyst. However, a catalyst is preferred in some instances. Examples of suitable catalysts include stannous octoate, dibutyl tin dilaurate, and tertiary amine compounds such as triethylamine and bis-(dimethylaminoethyl)ether, morpholine compounds such as β,β′-dimorpholinodiethyl ether, bismuth carboxylates, zinc bismuth carboxylates, iron (III) chloride, potassium octoate, potassium acetate, and DABCO® (diazabicyclo[2.2.2]octane), from Air Products. The preferred catalyst is a mixture of 2-ethylhexanoic acid and stannous octoate, e.g., FASCAT® 2003 from Elf Atochem North America. The amount of catalyst used is typically from about 5 to about 200 parts per million of the total weight of prepolymer reactants.

Prepolymer Neutralization

Optional neutralization of the prepolymer having pendant carboxyl groups converts the carboxyl groups to carboxylate anions, thus having a water-dispersibility enhancing effect. Suitable neutralizing agents include tertiary amines, metal hydroxides, ammonium hydroxide, phosphines, and other agents well known to those skilled in the art. Tertiary amines and ammonium hydroxide are preferred, such as triethyl amine (TEA), dimethyl ethanolamine (DMEA), N-methyl morpholine, and the like, and mixtures thereof. It is recognized that primary or secondary amines may be used in place of tertiary amines, if they are sufficiently hindered to avoid interfering with the chain extension process.

Chain Extenders

As a chain extender, at least one of water, inorganic or organic polyamine having an average of about 2 or more primary and/or secondary amine groups, polyalcohols, ureas, or combinations thereof is suitable for use in the present invention. Suitable organic amines for use as a chain extender include diethylene triamine (DETA), ethylene diamine (EDA), meta-xylylenediamine (MXDA), aminoethyl ethanolamine (AEEA), 2-methyl pentane diamine, and the like, and mixtures thereof. Also suitable for practice in the present invention are propylene diamine, butylene diamine, hexamethylene diamine, cyclohexylene diamine, phenylene diamine, tolylene diamine, 3,3-dichlorobenzidene, 4,4′-methylene-bis-(2-chloroaniline), 3,3-dichloro-4,4-diamino diphenylmethane, sulfonated primary and/or secondary amines, and the like, and mixtures thereof. Suitable inorganic amines include hydrazine, substituted hydrazines, and hydrazine reaction products, and the like, and mixtures thereof. Suitable polyalcohols include those having from 2 to 12 carbon atoms, preferably from 2 to 8 carbon atoms, such as ethylene glycol, diethylene glycol, neopentyl glycol, butanediols, hexanediol, and the like, and mixtures thereof. Suitable ureas include urea and its derivatives, and the like, and mixtures thereof. Hydrazine is preferred and is most preferably used as a solution in water. The amount of chain extender typically ranges from about 0.5 to about 0.95 equivalents based on available isocyanate.

Polymer Branching

A degree of branching of the polymer may be beneficial, but is not required to maintain a high tensile strength and improve resistance to creep—that is, recovery to that of or near its original length after stretching. This degree of branching may be accomplished during the prepolymer step or the extension step. For branching during the extension step, the chain extender DETA is preferred, but other amines having an average of about two or more primary and/or secondary amine groups may also be used. For branching during the prepolymer step, it is preferred that trimethylol propane (TMP) and other polyols having an average of about two or more hydroxyl groups be used. The branching monomers can be present in amounts tip to about 4 wt. % of the polymer backbone.

Plasticizers

The polyurethane of the present invention can be prepared in the presence of a plasticizer. The plasticizer can be added at any time during prepolymer preparation or dispersion or to the polyurethane during or after its manufacture. Plasticizers well known to the art can be selected for use in this invention according to parameters such as compatibility with the particular polyurethane and desired properties of the final composition, such as those listed in WIPO Publication WO 02/08327 A1 (incorporated herein by reference in its entirety). For example, polyester plasticizers tend to be more compatible with polyester-based polyurethanes. Reactive plasticizers can be used that react with functionality of the ingredients. For example, epoxy groups may be present in reactive plasticizers that react with other compounds such as aminated and hydroxylated compounds respectively. Ethylenically unsaturated groups may be present in reactive plasticizers that react with compounds having ethylenic unsaturation. Plasticizers can also be selected to impart particular properties such as flame retardancy to the polyurethanes, or to enhance particular properties such as wetting, emulsifying, conditioning, and UV absorption in end-use personal care applications. The plasticizers typically are used in amounts from about 2 wt. % to about 100 wt. %, preferably from about 5 to about 50 wt. %, and more preferably from about 5 to about 30 wt. %, based on polyurethane dry weight. The optimum amount of plasticizer is determined according to the particular application, as is well known to those skilled in the art.

Examples of suitable reactive plasticizers include compositions and mixtures having ethylenic unsaturation, such as triallyl trimellitate (TATM), Stepanol PD-200LV (a mixture of (1) unsaturated oil and (2) polyester diol reaction product of o-phthalic acid and diethylene glycol from Stepan Company), and the like, and mixtures thereof. Other suitable reactive plasticizers include epoxidized plasticizers, including certain monofunctional and polyfunctional glycidyl ethers such as Heloxy® Modifier 505 (polyglycidyl ether of castor oil) and Heloxy® Modifier 71 (dimer acid diglycidyl ether) from Shell Chemical Company, and the like, and mixtures thereof.

Examples of suitable flame retardant plasticizers include phosphorus-based plasticizers such as cyclic phosphates, phosphites, and phosphate esters, exemplified by Pliabrac™ TCP (tricresyl phosphate), Pliabrac™ TXP (trixylenyl phosphate), Antiblaze™ N (cyclic phosphate esters), Antiblaze™ TXP (tar acid, cresol, xylyl, phenol phosphates), and Antiblaze™ 524 (trixylyl phosphate) from Albright & Wilson Americas; Firemaster™ BZ 54 (halogenated aryl esters) from Great Lakes Chemicals; chlorinated biphenyl, 2-ethylhexyl diphenyl phosphate, isodecyl diphenyl phosphate, triphenyl phosphate, cresyl diphenyl phosphate, p-t-butylphenyl diphenyl phosphate, triphenyl phosphite, and the like. Other examples of phosphorus-based plasticizers include chlorinated alkyl phosphate esters such as Antiblaze™ 100 (chloro alkyl diphosphate ester) from Albright & Wilson Americas; alkyl phosphates and phosphites such as tributyl phosphate, tri-2-ethylhexyl phosphate, and triisoctyl phosphite; other organophosphates and organophosphites such as tributoxy ethylphosphate; other phosphates and phosphonates such as chlorinated diphosphate and chlorinated polyphosphonate; and the like. Mixtures can also be used.

Other Additives for Preparation of Dispersions

Other additives well known to those skilled in the art can be used to aid in preparation of the dispersions of this invention. Such additives include surfactants, stabilizers, defoamers, antimicrobial agents, antioxidants, UV absorbers, carbodiimides, and the like. The dispersions of this invention typically have total solids of at least about 20 wt. %, preferably at least about 25 wt. % and more preferably at least about 30 wt. %.

Overview of Applications

The waterborne polyurethane dispersions of the present invention can be processed by methods well known to those skilled in the art (including blending with other polymers and materials) to make coatings and films.

Additives such as activators, curing agents, stabilizers such as Stabaxol™ P200, colorants, pigments, neutralizing agents, thickeners, non-reactive and reactive plasticizers, coalescing agents such as di(propylene glycol) methyl ether (DPM), waxes, slip and release agents, antimicrobial agents, surfactants such as Pluronic™ F68-LF and IGEPAL™ CO630 and silicone surfactants, metals, antioxidants, UV stabilizers, antiozonants, and the like, can optionally be added as appropriate before and/or during the processing of the dispersions of this invention into finished products as is well known to those skilled in the art. Additives may be used as appropriate in order to make articles or to treat (such as by impregnation, saturation, spraying, coating, or the like) porous and non-porous substrates such as papers, non-woven materials, textiles, leather, wood, concrete, masonry, metals, house wrap and other building materials, fiberglass, polymeric articles, personal protective equipment (such as hazardous material protective apparel, including face masks, medical drapes and gowns, and firemen's turnout gear), and the like. Applications include papers and non-wovens; fibrous materials; films, sheets, composites, and other articles; flock and other adhesives; and; and the like. As these coatings are ink receptive they can use used as labels, tags etc., on articles and garments identifying size, use recommendations, cleaning recommendations, safety warnings, source, displaying trademarks or tradedress, etc. If desired, one would apply the ink receptive coating with or without other layers as an attachable printable surface to a woven, nonwoven, or other film. If one desires, the ink receptive coating can be added to another object like a banner, poster, signage, billboard, etc., as new printed matter to update another object with new, correct, or different information. It can be adhered to other objects via various adhesives, melt bonding, stitching, etc.

Any fibrous material can be coated, impregnated or otherwise treated with the compositions of the present invention by methods well known to those skilled in the art, including carpets as well as textiles used in clothing, upholstery, tents, awnings, and the like. Suitable textiles include fabrics, yarns, and blends, whether woven, non-woven, or knitted, and whether natural, synthetic, or regenerated. Examples of suitable textiles include cellulose acetate, acrylics, wool, cotton, jute, linen, polyesters, polyamides, polyolefins, regenerated cellulose (Rayon), paper and label stock, and the like.

Blends with Other Polymers and Polymer Dispersions

The waterborne polyurethane dispersions and final (dry) polyurethanes of the present invention can be combined with commercial polymers and polymer dispersions by methods well known to those skilled in the art. Such polymers and dispersions include those described in WIPO Publication WO 02/02657 A2 (incorporated herein by reference in its entirety). Blending can be done by simple mechanical mixing of dispersions or emulsions, or by dispersing prepolymer(s) into a pre-made dispersion or emulsion of another polymer to form a composite or hybrid of various architectures. Such other polymers and polymer dispersions include natural rubber, conjugated-diene-containing polymers including butadiene-containing copolymers with acrylonitrile and/or styrene (such as Hycar® nitrile copolymer emulsions and SBR copolymer emulsions from Lubrizol Advanced Materials, Inc.), polychlorobutadiene (Neoprene), hydrogenated styrene-butadiene triblock copolymers (such as Kraton™ copolymers from Shell Chemical), chlorosulfonated polyethylene (such as Hypalon™ polymers from E.I. duPont), ethylene copolymers (such as EPDM copolymers), acrylic and/or methacrylic ester copolymers (such as Hycar® acrylic copolymers from Lubrizol Advanced Materials, Inc.), vinyl chloride and vinylidene chloride copolymers (such as Vycar® copolymers from Lubrizol Advanced Materials, Inc.), polyisobutylenes, polyurethanes (such as Sancure® polyurethanes from Lubrizol Advanced Materials, Inc.), polyureas, and poly(urethane-urea)s. Among preferred compositions are those comprising acrylic copolymers and polyurethanes.

Suitable compositions include those described in the following U.S. patents, all of which are incorporated herein by reference. For example, U.S. Pat. No. 4,920,176 relates to emulsion polymerization in order to prepare nitrile rubber (NBR) latexes. Generally, nitrile latexes comprise polymerized units of butadiene, acrylonitrile, and acrylic acid or methacrylic acid. Additional comonomers can be included to change or improve polymer properties. These include vinylpyridine, acrylic and methacrylic ester monomers, chlorobutadiene, cross-linking agents, styrenic monomers, and the like.

U.S. Pat. No. 6,017,997 relates to preparation of waterborne polyurethane, polyurea, and poly(urethane-urea) dispersions (“PUD”). Generally, PUD comprises polymerized units of diisocyanate and hydrophylic moiety, together with diol, diamine, or both diol and diamine. However, all four units can have pre-polymerization functionality (i.e., number of reactive groups) higher than two. Diisocyanates can be aliphatic, such as 1,6-hexamethylene diisocyanate, cyclohexane-1,4 (or -1,3)-diisocyanate, isophorone diisocyanate, bis-(4-isocyanatocyclohexyl)-methane, 1,3- and 1,4-bis(isocyanatomethyl)cyclohexane, bis-(4-isocyanato-3-methyl-cyclohexyl)methane, tetramethyl xylylene diisocyanate, and the like. Diisocyanates can also be aromatic, such as 2,4-diisocyanato toluene, 2,6-diisocyanato toluene, 4,4′-diisocyanato diphenyl methane, and the like.

Suitable opacifiers include glycol fatty acid esters; alkoxylated fatty acid esters; fatty acid alcohols; hydrogenated fatty acids, waxes and oils; kaolin and other clays; magnesium silicate; calcium carbonates; titanium dioxide; silica; and the like, and mixtures thereof. Such suitable opacifiers typically comprise about 0.1 wt. % to about 70 wt. %, preferably about 0.5 wt. % to about 66 wt. %, and more preferably about 1 wt. % to about 50 wt. % of the total weight of the compositions of the present invention. In some aspects when used in higher amounts these opacifiers also function as fillers.

Suitable surfactants include a wide variety of nonionic, cationic, anionic, and zwitterionic surfactants, such as those disclosed in McCutcheon's Detergents and Emulsifiers, North American Edition (1986), Allured Publishing Corporation; and in U.S. Pat. Nos. 3,755,560, 4,421,769, 4,704,272, 4,741,855, 4,788,006, and 5,011,681. Such suitable surfactants typically comprise about 0.1 wt. % to about 25 wt. %, preferably about 0.5 wt. % to about 25 wt. %, and more preferably about 1 wt. % to about 15 wt. % of the total weight of the personal care compositions of the present invention.

The following examples are presented for the purpose of illustrating the invention disclosed herein in greater detail. However, the examples are not to be construed as limiting the invention herein in any manner, the scope of the invention being defined by the appended claims.

### EXAMPLES

### Chemicals Used in Examples

Permax™ 200 urethane—a commercially polyurethane dispersion available from Lubrizol Advanced Materials, Inc. in Cleveland, Ohio with about 20 wt. % lateral side chain poly(alkylene oxide) segments and having high moisture vapor transmission rates. Generally, described in U.S. Pat. No. 6,576,702.

Carbopol® EP-1 polymer—a commercially available polyacrylic acid based thickener available from Lubrizol Advanced Materials, Inc. in Cleveland, Ohio.

Rheolate™ 288 polymer—urethane associative thickener commercially available from Elementis.

Sancure® 20025 urethane—a commercially available nonionic polyurethane dispersion without lateral side chain poly(alkylene oxide) that is available from Lubrizol Advanced Materials, Inc. in Cleveland, Ohio.

### Example 1

Two examples of ink jet formulas we have made—in dry parts recipes

RECIPE 1

| 1. | Permax ™ 200 - | 100 phr (aliphatic nonionic | |
|---|---|---|---|
| 2. | Calcium carbonate | 80 | phr |
| 3. | Alum (an aluminum sulfate compound) | 5 | phr |
| 4. | Defoamer - | 0.35 | phr |

| | | |
|---|---|---|
| 5. | Thickener - Carbopol EP-1 acrylic | (0-.5) phr. or as needed |
| | acid or Urethane associative type | to get to desired viscosity |
| | like Rheolate 288 | |
| 6. | Ammonia (28%) to adjust pH to 8.0 | |
| 7. | Water to adjust total solids as | |
| | needed to 35-40% TS. | |

RECIPE 2

| 1. | Sancure ® 20025 | 100 | phr |
|---|---|---|---|
| 2. | Calcium carbonate | 80 phr (e.g. 0-200 phr) | |
| 3. | Alum (aluminum sulfate compound) | 5 | phr |
| 4. | Defoamer - | 0.35 | phr |

| | | |
|---|---|---|
| 5. | Thickener - Carbopol EP-1 acrylic | (0-.5 phr) as needed to |
| | acid or Urethane associative type | get to desired viscosity |
| | like Rheolate 288 | |
| 6. | Ammonia (28%) to adjust pH to 8.0 | |
| 7. | Water to adjust total solids as | |
| | needed to 35-45% TS. | |

We have used fumed silica in place of or in addition to the calcium carbonate to make a matt finish. Fumed silica is used at lower levels like 0-15 phr.
Both of these formulations have been coated on fabrics and printed with solvent and waterborne inks via inkjet printers to create images. The images were generally more vibrant, clearer, or with more realistic color than several controls using other coatings.

The following eight recipes (Recipes 3-10) use blends of the polyurethane components with other polymers or hybrids with polyurethane components. These Recipes 3-10 are anticipated but not yet formulated and tested.

RECIPE 3

| 1. | Blend of nonionic stabilized | 100 | phr |
|---|---|---|---|
| | polyurethane Dispersion with a | | |
| | commercial nonionic acrylic Latex | | |
| | (10:90 to 90:10 wt. ratio of | | |
| | polyurethane to acrylic) | | |
| 2. | Calcium carbonate | 80 phr (e.g. 0-200 phr) | |
| 3. | Alum (aluminum sulfate compound) | 5 | phr |
| 4. | Defoamer - | 0.35 | phr |

| | | |
|---|---|---|
| 5. | Thickener - Carbopol EP-1 acrylic | (0-.5 phr) as needed to |
| | acid or Urethane associative type | get to desired viscosity |
| | like Rheolate 288 | |
| 6. | Ammonia (28%) to adjust pH to 8.0 | |
| 7. | Water to adjust total solids as | |
| | needed to 35-45% TS. | |

Recipe 4
Same as recipe 3 but substitute a blend of a nonionic polyurethane dispersion and a commercial nonionic styrene-acrylic copolymer (10:90 to 90:10 wt. ratio) for the blend of nonionic polyurethane and commercial nonionic acrylic latex.
   Recipe 5
Same as Recipe 3 but substitute a blend of nonionic polyurethane dispersion and nonionic polyvinyl chloride (10:90 to 90:10 wt. ratio) for the blend of nonionic polyurethane and commercial nonionic acrylic latex.
   Recipe 6
Same as Recipe 3, but substitute a blend of nonionic polyurethane dispersion and nonionic polyvinyl chloride-co-acrylate hybrid polymer (10:90 to 90:10 wt. ratio) for the nonionic polyurethane dispersion and commercial nonionic acrylic latex.
   Recipe 7
Same as Recipe 3, but substitute a hybrid system, e.g., acrylic polymer polymerized onto a nonionic polyurethane dispersion (10:90 to 90:10 wt. ratio) for the nonionic polyurethane dispersion and commercial acrylic latex.
   Recipe 8
Same as Recipe 3, but substitute a hybrid system, e.g., styrene-acrylic polymer polymerized onto a nonionic polyurethane dispersion (10:90 to 90:10 wt. ratio) for the nonionic polyurethane dispersion and commercial nonionic acrylic latex.
   Recipe 9
Same as Recipe 3, but substitute a hybrid system, e.g., vinyl chloride polymerized onto a nonionic polyurethane dispersion (10:90 to 90:10 wt. ratio) for the nonionic polyurethane dispersion and commercial nonionic acrylic latex.
   Recipe 10
Same as Recipe 3, but substitute a hybrid system, e.g., vinyl chloride and acrylate monomers polymerized onto a nonionic polyurethane dispersion (10:90 to 90:10 wt. ratio) for the nonionic polyurethane dispersion and commercial nonionic acrylic latex.

While in accordance with the patent statutes the best mode and preferred embodiment has been set forth, the scope of the invention is not limited thereto, but rather by the scope of the attached claims.

1. A composition for ink receptive coatings comprising:
a) a nonionically stabilized polyurethane dispersion in aqueous media, and
b) a particulate filler and/or an additional polymer,
wherein said nonionically stabilized polyurethane dispersion is present in said composition in an amount of at least 10 wt. % of the weight of said coating and said nonionically stabilized polyurethane dispersion comprises at least 10 wt. % of nonionic polymeric stabilizing moieties having at least ethylene oxide and/or propylene oxide repeating units.

2. A composition according to claim 1, wherein said polyurethane dispersion wherein at least 50 wt. % are derived from aliphatic diisocyanates.

3. A composition according to claim 1, wherein said particulate filler is present and carries a cationic charge.

4. A composition according to claims 1, further comprising at least 0.5 wt. % of at least one water soluble inorganic salts.

5. A composition according to claim 4, wherein said at least one inorganic salts comprises alum, calcium chloride, and/or aluminum chloride.

6. A composition according to claim 1, wherein said particulate filler is present and carries an anionic or nonionic charge.

7. An ink receptive coating for a woven or nonwoven substrate comprising:
a) a nonionically stabilized polyurethane dispersion in aqueous media, and
b) an particulate filler and/or additional polymer,
wherein said nonionically stabilized polyurethane dispersion is present in said composition in an amount of at least 10 wt. % of the weight of said coating and said nonionically stabilized polyurethane dispersion comprises at least 10 wt. % of nonionic polymeric stabilizing moieties having at least ethylene oxide and/or propylene oxide repeat units.

8. An ink receptive coating according to claim 7, wherein said nonionically stabilized polyurethane dispersion comprises from about 12 to about 80 wt. % of poly(alkylene oxide) side-chain units based on the weight of the polyurethane in said dispersion.

9. A printed article comprising:
a) a woven, non-woven, paper, or film substrate,
b) an ink receptive coating applied directly to said substrate or applied to one or more intervening coatings on said substrate,
c) an ink image in or on said ink receptive coating,
wherein said ink receptive coating is characterized as comprising a polyurethane dispersion having a) at least 5 wt. % pendant or side-chain (e.g., lateral) poly(alkylene oxide) incorporated into said polyurethane dispersion and/or b) at least 0.5 wt. % poly(alkylene oxide) based surfactant based on the weight of said polyurethane in said polyurethane dispersion.

10. A printed article according to claim 9, wherein said pendant or side-chain poly(alkylene oxide) is present from about 12 wt. % to about 80 wt. % based on the weight of the polyurethane in said polyurethane dispersion.

11. A printed article according to claim 9, wherein said printed article comprises a water-borne ink jet image.

12. A printed article according to claim 9, wherein said printed article comprises a solvent-borne ink jet image.

13. A printed article according to claim 9, further including in said ink receptive coating from about 10 to about 400 parts by weight of one or more acrylate polymers or copolymers, vinyl acetate polymers or copolymers, or (vinyl chloride) polymer or copolymers per each 100 parts by weight of polyurethane in said ink receptive coating.

14. A printed article according to claim 9, further comprising a rheology modifying polymer in an amount from about 0.1 to about 5 parts by weight per 100 parts by weight of polyurethane, said rheology modifying polymer characterized as a water soluble polymer.

15. A printed article according to claim 9, further including at least 0.5 parts by weight of an inorganic salt per 100 parts by weight of polyurethane in said ink receptive coating.

16. A printed article according to claim 15, wherein said inorganic salt comprises alum.

17. A printed article according to claim 9, wherein said ink receptive coating further comprises at least 10 parts by weight of a filler selected from talc, calcium carbonate, TiO₂, and precipitated silica per each 100 parts by weight of polyurethane in said ink receptive coating.

18. A printed article according to claim 9, wherein said printed image comprises two or three or more separate pigments or dyes.

19. A printed article according to claim 9, wherein said ink receptive coating further comprises cationic polymer and/or inorganic salts in amounts of at least 0.5 parts by weight per 100 parts by weight polyurethane, wherein said cationic polymer is selected from polymers based on acrylic, acrylamide, and/or epichlorohydrin monomers, or cationically modified natural gums or similarly modified starches; and said inorganic salts are selected from calcium chloride or aluminum chloride.
